(19) United States
(12) Patent Application Publication
(10) Pub. No.: US 2006/0020555 A1
(43) Pub. Date: Jan. 26, 2006

(54) Monitoring a license proxy

(76) Inventor: Daven Walt Septon, Loveland, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/899,975

(22) Filed: Jul. 26, 2004

(51) Int. Cl. G06F 17/60

(52) U.S. Cl. 705/59

(57) ABSTRACT

Methods and systems for monitoring a license proxy are disclosed. In one embodiment, the system comprises an application, a license proxy process, communicatively coupled to the application, to periodically transmit a heartbeat to a license server, and a monitoring agent to monitor the license proxy process, and upon detecting a failure of the license proxy process while at least one license is being used by the application, to change a status to indicate at least one license needs to be reacquired by the license proxy process.

### BACKGROUND

License servers are used to manage licenses to enable or enhance capabilities of applications. The licenses issued by the license server may be “node lock” licenses for a single machine or “floating” licenses, which are not machine specific. As illustrated in FIG. 1, an application 100 issues a request for a license to a license server 110. If a license is available, the license server 110 issues the license.

To maintain compliance with licensing agreements, the number of licenses issued is tracked by the license server 110. However, if the license server 110 fails, the entire quantity of licenses may become available when it restarts. License over-usage may become possible with one or more existing applications 100 having licenses that were obtained before failure of the license server and new applications obtaining licenses after the license server 110 restarts.

In order to prevent license over-usage, a heartbeat may be sent from the application 100 to the license server 110 at predetermined time intervals. If the license server 110 fails, the application 100 will not receive an acknowledgement to the heartbeat and appropriate action can be taken. A typical heartbeat execution time may be measured in milliseconds. This may be a large amount of time and performance may be overly degraded for time-critical applications that measure time in nanoseconds or picoseconds.

### SUMMARY OF THE INVENTION

Methods and systems for monitoring a license proxy process are disclosed. In one embodiment, the system comprises an application and a license proxy process communicatively coupled to the application. The license proxy process periodically transmits a heartbeat to a license server. The system further comprises a monitoring agent to monitor the license proxy process. If the monitoring agent detects a failure of the license proxy process while at least one license is being used by the application, a status is changed to indicate at least one license needs to be reacquired.

### BRIEF DESCRIPTION OF THE DRAWINGS

Illustrative and presently preferred embodiments of the invention are illustrated in the drawings, in which:

FIG. 1 illustrates a prior art system that may be used to transmit heartbeats to a license server;

FIGS. 2A & 2B illustrate exemplary systems with license proxy processes that may be used to monitor a license proxy process;

FIG. 3 illustrates an exemplary configuration of the system of FIG. 2A;

FIG. 4 illustrates an exemplary method for transmitting heartbeats to a license server using a license proxy process;

FIG. 5 illustrates an exemplary method for maintaining licenses for which a license proxy process is communicating heartbeats; and

FIG. 6 illustrates an exemplary method that may be used to obtain or reacquire a license for an application using a license proxy process.

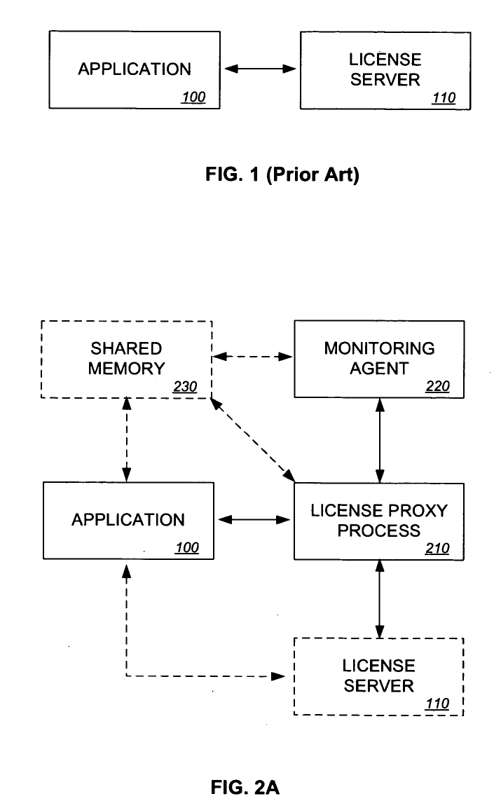

### DETAILED DESCRIPTION OF THE INVENTION

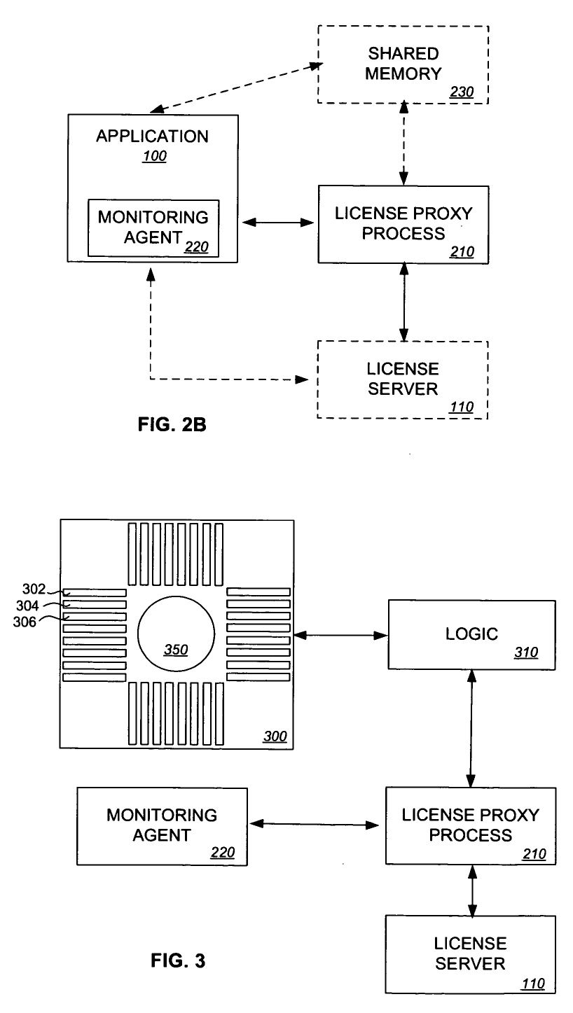

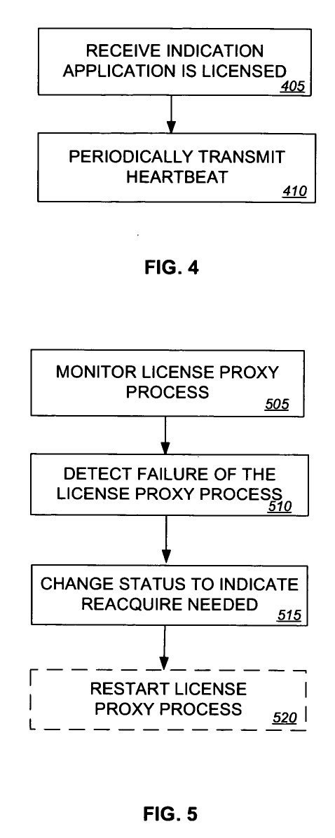

An exemplary embodiment of a system that uses a monitoring agent to monitor a license proxy process is illustrated in FIG. 2A. The system includes an application 100 (e.g., a time-critical application) communicatively coupled to a license proxy process 210. A communicative coupling is a coupling that allows communication between license proxy process 210 and application 100. This may be by means of a socket or other software coupling, and/or a bus, cable, network, wireless mechanism, or other mechanism. Thus, it should be appreciated that license proxy process 210 and application 100 may reside on the same or different machines. It should also be appreciated that in some embodiments, the application 100 may be a component (e.g., process) of a larger application program. As will be described in further detail below with reference to FIG. 4, the license proxy process 210 may be responsible for heartbeat communications with a license server 110.

Failure of the license proxy process 210 may cause the license server 110 to release licenses for which the license proxy process 210 is maintaining heartbeat communications. Thus, the system further comprises a monitoring agent 220 to monitor the license proxy process 210. By way of example, the monitoring agent 220 may monitor the license proxy process 210 by sending a periodic heartbeat to the license proxy process 210. If the monitoring agent 220 detects a failure of the license proxy process while at least one license is being used by the application 100 or other applications (not shown), the monitoring agent 220 may change a status to indicate at least one license needs to be reacquired. The monitoring agent 220 may also restart the license proxy process 210.

FIG. 2B illustrates a variant of the system shown in FIG. 2A. The difference between the systems shown in FIGS. 2A and 2B is that, in FIG. 2B, the monitoring agent 220 is part of the application 100. In this manner, any failure of the monitoring agent 220 is detected by the application 100 and causes the application 100 to terminate. This avoids the need for monitoring agents that monitor other monitoring agents.

In one embodiment, the status may be stored in a shared memory 230 that is communicatively coupled to the license proxy process 210 and the monitoring agent 220 (and also, possibly, to the application 100). The status may be a Boolean flag or other type of variable that the license proxy process may read after it is restarted. Optionally, the shared memory may include additional information such as that shown in Table 1. This information may be useful to determine the number of licenses that need to be reacquired in configurations in which license proxy process 210 is responsible for heartbeat communications for multiple licenses for application 100 and/or additional applications.

TABLE 1

| | | | Num |
|---|---|---|---|
| License Type | Status | Num | Reacquired |
| A | OUT | 3 | 2 |
| B | IN | 0 | 0 |
| C | OUT | 1 | 1 |

As shown in Table 1, there are three license types (A, B, C) for which license proxy process 210 is communicating heartbeats to the license server 110. Table 1 illustrates a point in time, sometime after the license proxy process 210 has failed and all licenses have not yet been reacquired. The values in the “Num” column indicate the number of licenses that were acquired by the license proxy process 210 prior to its failure and restart (and possibly prior to more than one failure and restart). Preferably, the values in the “Num” column are populated by the license proxy process 210 as it acquires licenses. The values in the “Num Reacquired” column indicate the number of licenses that the license proxy process 210 has reacquired since its restart (i.e., two type A licenses and one type C license). In the state shown in Table 1, one type A license still needs to be reacquired.

Upon a failure of the license proxy process 210, the values in the “Num” client will remain, but the values in the “Num Reacquired” column will be cleared by the monitoring agent 220. It should be noted that repeated failures of the license proxy process may result in the “Num Reacquired” values being cleared prior to the license proxy process 210 reacquiring all of the licenses reflected in the “Num” column.

If the license proxy process 210 cannot reacquire the licenses noted in the “Num” column within a predetermined time (or after a predetermined number of tries), appropriate action may be taken, such as a notification to the application 100, a halt of the application, or a limit of functionality of the application 100.

It should be appreciated that in alternate embodiments, the shared memory may not include all of the information in Table 1 and/or may include additional information that may be used to reacquire one or more licenses.

In one embodiment, the system may additionally include the license server 110. The license server 110 is communicatively coupled to the license proxy process 210 and optionally coupled to application 100. By way of example, the license server may be a Macrovision Corporation's (a Delaware Corporation having its principal place of business in Santa Clara, Calif.) FLEXlm™ license server. Other license servers may also be used. The license server 110 may be used to issue and control licenses for one or more applications, such as application 100. Licenses issued by the license server may be used to enable application 100 or sub-processes of application 100, or enhance or govern capabilities of the application 100.

An exemplary embodiment of a system using a license proxy process 210 is illustrated in FIG. 3. The system includes a tester 300 to test a device 350. By way of example, device 350 may be a system-on-a-chip (SOC). It should be appreciated that at times, tester 300 will not be coupled to a device 350.

Tester 300 includes a plurality of boards 302-306. Each board may include a plurality of pins (not shown) that may be used to drive inputs and receive outputs from device 350. In one embodiment, each pin may include its own memory to use during the testing of the device. The memory may be used to store pin specific vector information. In alternate embodiments, memory may not be included on each pin, but may instead be included for each board or other component of tester 300.

The system also includes logic 310 communicatively coupled to tester 300. Logic 310 may be part of a test operating system on a workstation coupled to tester 300 via a communication link, such as an optical link and may be used to control the tester 300. In one embodiment, logic 310 may communicate with firmware (not shown) on tester 300 to send tests to device 350 and receive test results. In an alternate embodiment, logic 310 may be part of the firmware of tester 300.

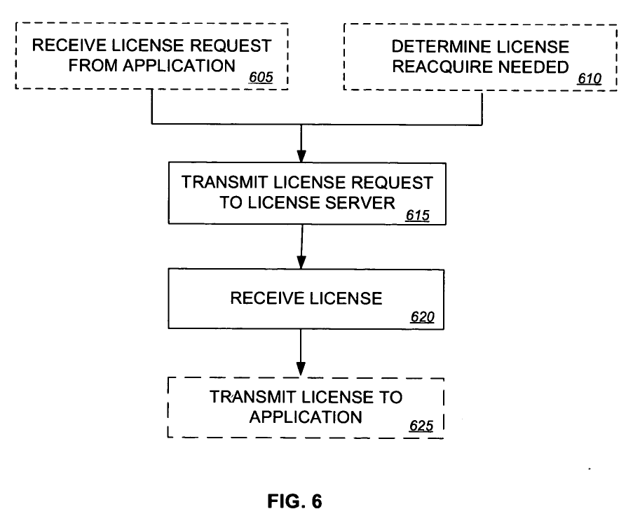

A license may be required to enable the tester 300 or to enable or govern one or more capabilities of the tester 300. By way of example, a license may be used to enable all of the capabilities of the tester 300 or may be used to grant limited use of resources on the tester 300. As will be described in further detail below with reference to FIG. 6, logic 310 may obtain the license from the license server 110 using a license proxy process 210. Alternately, logic 310 may obtain the license directly from license server 110. After a license has been obtained, the license proxy process 210 may be used to issue heartbeat communications to the license server 110 and monitoring agent 220 may be used to monitor the license proxy process 210.

FIG. 4 illustrates an exemplary method that may be used to transmit heartbeats to the license server 110. An indication is received 405 at the license proxy process 210 that the application 100 is licensed. In one embodiment, the indication may be received from the application 100 after the application 100 has obtained a license from the license server 110. As will be described with reference to FIG. 6, in an alternate embodiment, the license proxy process 210 may obtain a license from the license server 110 for the application and use the received license as the indication. Alternate indications are also contemplated.

After receiving the indication, the license proxy process 210 periodically transmits 410 a heartbeat to the license server 110. The heartbeat may be transmitted at predetermined time intervals which are timed to discover failure of the license server 110. If the license server is running, the license server may send an acknowledgement to each of the periodic heartbeats to the license proxy process 210. If the license server 110 is not running, an acknowledgement to the heartbeat will not be received.

In some embodiments, if an acknowledgement to the heartbeat is not received, the license under which the application is running may no longer be valid (e.g., because the license server 110 released all licenses during failure). If the license proxy process 210 determines that the license is not valid, either because it failed to receive an acknowledgement to the heartbeat, or other reason, it can then take appropriate action. By way of example, the license proxy process 210 may notify the application 100 and/or may attempt to reacquire a license from license server 110. The application 100 may continue to run, or the application 100 may be halted until a license can be reacquired.

Thus, the heartbeat may be used to help prevent license over-usage. The heartbeat transmittal 410 may also serve as notification to the license server 110 that the license is being used by the application 100 and may be used to automatically reissue the license to application 100 after license server 110 has been restarted after failure. It should be appreciated that by using a license proxy process 210 to communicate heartbeats to the license server 110, license over-usage may be prevented with minimal or no impact on performance of application 100.

FIG. 5 illustrates an exemplary method that may be used to maintain licenses for which license proxy process 210 is communicating heartbeats. Monitoring agent 220 monitors 505 the license proxy process 210. By way of example, monitoring agent 220 may monitor 505 the license proxy process 210 by periodically transmitting a heartbeat to the license proxy process 210. Other methods of monitoring 505 the license proxy process are also contemplated.

Upon detecting 510 a failure of the license proxy process 210 (e.g., by failing to receive an acknowledgement to at least one of the periodic heartbeats), the monitoring agent 220 changes 515 a status, such as a status stored in memory shared with license proxy process 220, to indicate one or more licenses need to be reacquired. Application 100 may continue to run while the licenses are being reacquired. Alternately, application 100 may be halted until the licenses it is using are reacquired. In one embodiment, the monitoring agent 220 may also be responsible for restarting 520 the license proxy process 210.

FIG. 6 illustrates an exemplary method that may be used to initially obtain and/or reacquire a license for application 100 using license proxy process 210. The method may begin by receiving 605, at the license proxy process 210, a request for a license from application 100. In some embodiments, the license proxy process may initiate the license request for future use of an application 100 and the method may begin with 615.

Alternately, when the method is used to reacquire licenses, the method may begin by the license proxy process 210 determining 610 at least one license needs to be reacquired. The license proxy process may make this determination 610 by obtaining a status from memory shared with the monitoring agent 220. The status may be obtained when the license proxy process 210 restarts and/or on a periodic basis, such as predetermined time intervals or when a heartbeat is received from the monitoring agent 220.

After receiving a request 605 for a license from an application 100 determining 610 a license needs to be reacquired, the license proxy process 210 transmits 615 a license request to the license server 110. In response to the request, the license proxy process 210 receives 620 a new license or a replacement license (to replace a license that was relinquished when the license proxy process 210 failed) from the license server 110. It should be appreciated that before issuing the license, the license server 110 may check to make sure that a license is available.

In some instances, a license may not be available and instead of receiving 620 a license, the license proxy process 210 may instead receive notification from the license server 110 that no licenses are available. If the license proxy process 210 is attempting to reacquire one or more licenses that were previously obtained for application 100, the application 100 may continue to run or may halt until licenses can be reacquired. License proxy process 210 may periodically re-attempt to reacquire the licenses until all the licenses have been acquired.

In one embodiment in which license proxy process 210 may be responsible for heartbeat communications for multiple licenses, a field indicating the number of licenses that need to be reacquired may be updated after receiving 620 a replacement license. This field may be a field in memory and may be for a specific license type, as shown in Table 1. After all licenses have been reacquired, the license proxy process 210 may change the status to indicate license acquisition is not necessary.

If the method was used to obtain a new license for the application 100, the license proxy process may optionally transmit 625 the license to the application 100 after it is received 620. In an alternate embodiment, the license proxy process 210 may instead only indicate to the application 100 that a license has been obtained. After the application 100 has finished using the license (e.g., logic has finished executing tests on tester 300), the application 100 may send a notification to the license proxy process 210 that the license is no longer needed. The license proxy process 210 may then transmit a request to free the license to the license server 110. In one embodiment, this may be done by forwarding the notification received from the application 100. The license server 110 may then make the license available to other applications.

While illustrative and presently preferred embodiments of the invention have been described in detail herein, it is to be understood that the inventive concepts may be otherwise variously embodied and employed, and that the appended claims are intended to be construed to include such variations, except as limited by the prior art. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. Alternatively, the methods may be performed by a combination of software, firmware, and/or hardware.

What is claimed is:

1. A system comprising:
an application;
a license proxy process, communicatively coupled to the application, to periodically transmit a heartbeat to a license server; and
a monitoring agent to monitor the license proxy process, and upon detecting a failure of the license proxy process while at least one license is being used by the application, to change a status to indicate at least one license needs to be reacquired by the license proxy process.

2. The system of claim 1, further comprising a shared memory, communicatively coupled to the license proxy process and the monitoring agent, to store the status.

3. The system of claim 2, wherein the monitoring agent is further to restart the license proxy process if the license proxy process fails.

4. The system of claim 1, wherein the monitoring agent monitors the license proxy process by sending a periodic heartbeat to the license proxy process.

5. The system of claim 1, further comprising the license server, communicatively coupled to the license proxy process, to issue the license.

6. The system of claim 5, wherein the license server is further to transmit an acknowledgement to at least one of the periodic heartbeat to the license proxy process.

7. The system of claim 1, wherein the application comprises logic to control a device tester.

8. The system of claim 7, further comprising a tester, communicatively coupled to the logic, to test a device.

9. A method comprising:
periodically transmitting a heartbeat from a license proxy process to a license server;
monitoring the license proxy process to detect a failure of the license proxy process; and
after detecting a failure, changing a status to indicate one or more licenses need to be reacquired by the license proxy process.

10. The method of claim 9, further comprising after detecting the failure of the license proxy, restarting the license proxy.

11. The method of claim 10, further comprising reacquiring at least one of the one or more licenses.

12. The method of claim 11, wherein reacquiring the licenses comprises:
transmitting a license request from the license proxy process to a license server; and
receiving, at the license proxy process, a replacement license for the application.

13. The method of claim 12, further comprising, after receiving the replacement license, updating a field indicating the number of licenses that need to be reacquired.

14. The method of claim 13, wherein updating a field comprises updating a field associated with a license type of the license.

15. The method of claim 11, further comprising after reacquiring all of the one or more licenses, changing the status to indicate license acquisition is not necessary.

16. The method of claim 10, further comprising after restarting the license proxy process, transmitting a heartbeat from the license proxy process to the license server.

17. The method of claim 16, wherein monitoring the license proxy process comprises at predetermined time intervals, sending a heartbeat to the license proxy process.

18. The method of claim 17, wherein detecting a failure comprises failing to receive an acknowledgement to the periodic heartbeat.

19. The method of claim 9, wherein changing a status comprises changing a status of a memory shared with the license proxy process.

20. At least one machine-readable medium having stored thereon sequences of instructions, which, when executed by a machine, cause the machine to perform the actions of:
defining an agent, the agent defined to start a license proxy process for one or more applications, to detect failures of the license proxy process, and upon detection of a failure, to 1) restart the license proxy process, and 2) set a status indicating that licenses need to be reacquired by the license proxy process; and
defining a license proxy process, the license proxy process defined to obtain licenses needed by the one or more applications, to reacquire the licenses when the status indicates the licenses need to be reacquired, and to revise the status upon reacquiring the licenses.
